(19) United States
(12) Patent Application Publication
(10) Pub. No.: US 2002/0046115 A1
(43) Pub. Date: Apr. 18, 2002

(54) Advertisement distribution method, data processing method, communication terminal apparatus, data communication system and information storage medium

(75) Inventor: Yasuyoshi Yamada, Saitama (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/946,727

(22) Filed: Sep. 6, 2001

(30) Foreign Application Priority Data
Sep. 6, 2000 (JP) 2000-270360

(51) Int. Cl. G06F 17/60

(52) U.S. Cl. 705/14

(57) ABSTRACT

An intermediary agency enters into a contract with general users with respect to data distribution of an advertisement of goods, which was asked by advertisement clients, and the intermediary agency sets offer conditions of the advertisement of the goods and advertisement data in communication terminal apparatuses 14 of the general users. Since the advertisement data are offered in accordance with the offer conditions when the general users use these communication terminal apparatuses 14, the advertisement of the goods is offered to a number of general users as data with good efficiency.

### BACKGROUND OF THE INVENTION

The present invention relates to an advertisement distribution method of an intermediary agency for conducting data distribution to general users of an advertisement of goods, which is asked by an advertisement client, a communication terminal apparatus to be utilized for this advertisement distribution method, a data processing method thereof, a data communication system in which this communication terminal apparatus, an agency terminal apparatus and a client terminal apparatus are connected to each other by a communication network, and an information storage medium in which software for a computer of the communication terminal apparatus is stored.

Presently, communication terminal apparatuses, such as a mobile phone and a personal computer capable of mutually conducting data communication via a communication network, are generally popularized, and by utilizing such a communication terminal apparatus, data distribution to general users of an advertisement of goods is also conducted. For example, since a personal computer can conduct data communication using text data by mean of an electronic mail, data distribution of an advertisement of goods to personal computers of general users is conducted.

Also, since the personal computer can conduct data inspection of a homepage established in an internet that is a communication network, a number of advertisement data are offered in a homepage of an enterprise and so forth, and advertisement data called a banner advertisement are also offered in a homepage of a general user.

On the other hand, since the current mobile phone generally has a liquid crystal display and can also conduct data communication of an electronic mail, data distribution thereto of an electronic mail for an advertisement of goods is conducted. Also, since the current mobile phone can conduct data inspection of information contents similar to a homepage of an internet, various kinds of advertisement data are set as data also in the information contents.

Accordingly, when the general users conduct data inspection of a homepage and information contents by means of the personal computer and the mobile phone, advertisement data offered there as data are provided to the general users.

In addition, usually, the personal computers of the general users are connected to an internet by means of an agency terminal apparatus of a provider agency, and the provider agency collects a fee of this connection from the general users. However, presently, there are some provider agencies that offer advertisement data of an advertisement of goods from the agency terminal apparatuses to the communication terminal apparatuses connected to an internet, and instead of this, provide a free charge or a discount for a connection fee.

Presently, for offering an advertisement of goods to general users as data, as mentioned above, the communication terminal apparatuses such as a mobile phone and a personal computer, which spread to the general users, are utilized, and to use data reception of advertisement data as an alternative to a connection fee of an internet is also conducted.

However, presently, as a method of offering an advertisement of goods to general users as data utilizing the communication terminal apparatuses, as mentioned above, only data distribution of an electronic mail of an advertisement of goods to the communication terminal apparatuses, and data offer of an advertisement of goods to a homepage and information contents, data of which are inspected by the communication terminal apparatus, are conducted.

In other words, although the communication terminal apparatuses such as the current mobile phone and personal computer have various kinds of functions, only a part of the functions is utilized for the data offer of the advertisement data, and accordingly, the communication terminal apparatuses for offering the advertisement of the goods to the general users as data are not fully utilized.

### SUMMARY OF THE INVENTION

The present invention was made in the light of the above-mentioned tasks, and the objective thereof is to provide at least one of an advertisement distribution method capable of fully offering an advertisement of goods as data to general users utilizing popular communication terminal apparatuses, a communication terminal apparatus to be utilized for this advertisement distribution method, a data processing method thereof, a data communication system in which this communication terminal apparatus, an agency terminal apparatus and a client terminal apparatus are connected to each other by a communication network, and an information storage medium in which software for a computer of the communication terminal apparatus is stored.

An advertisement distribution method of the present invention is performed by utilizing a data communication system, and in the data communication system, communication terminal apparatuses of general users mutually conduct data communication with each other via a communication network.

Here, when an intermediary agency is asked by an advertisement client to offer an advertisement of goods to the general users, this intermediary agency enters into a contract with the general users with respect to data distribution of the advertisement of the goods, and sets offer conditions thereof as data in the communication terminal apparatuses. Further, since the intermediary agency distributes advertisement data of the advertisement of the goods as data from an agency terminal apparatus to the communication terminal apparatuses in which these offer conditions are set as data, these distributed advertisement data of the advertisement of the goods are held in the communication terminal apparatuses as data. Then, since these communication terminal apparatuses offer these held advertisement data of the advertisement of the goods to the general users as data in accordance with the offer conditions that were set as data, the advertisement of the goods is offered as data to the general users under the offer conditions contracted with the intermediary agency.

With regard to such offer conditions of the communication terminal apparatuses for offering the advertisement of the goods to the general users as data, the communication terminal apparatuses can offer the advertisement data as data when performing a predetermined operation by means of a manual operation of the general users, and also, the communication terminal apparatuses display and output the advertisement data when performing the predetermined operation in accordance with the manual operation as far as the display and output of various kinds of data are not hindered.

Also, it is possible to offer the advertisement data as data when the predetermined operation in association with data communication with other communication terminal apparatuses is performed, and for example, it is possible to offer the advertisement data as data in accordance with calls of other communication terminal apparatuses. Further, it is possible to display and output the advertisement data as far as the display and output of text data to be operated by means of an input and transmitted to other communication terminal apparatuses are not hindered, and it is also possible to display and output the advertisement data as far as the display and output of text data received as data from other communication terminal apparatuses are not hindered.

Also, when input voice is transmitted as data and received data are output by voice to conduct data communication with other communication terminal apparatuses, it is possible to output the advertisement data by voice as far as the voice output is not hindered, and it is also possible to transmit the advertisement data as data to other communication terminal apparatuses with which the communication terminal apparatuses conduct data communication.

In other embodiment of the present invention, by means of a client terminal apparatus the advertisement client mutually conducts data communication with an agency terminal apparatus via a communication network, and at least one of an offer request of the advertisement of the goods, and the advertisement data is transmitted as data to the agency terminal apparatus from the client terminal apparatus, and thereby, since, by means of the data transmission from the client terminal apparatus, the offer request of the advertisement of the goods and the advertisement data are controlled in real time in the agency terminal apparatus, for example the advertisement data are promptly distributed as data to the communication terminal apparatuses of the general users.

In addition, the advertisement of the goods in the present invention can be one for propagating tangible or intangible goods, and is represented by a text, a static image, a dynamic image, voice, a combination thereof and so forth. Also, the various kinds of means in the present invention can be formed so as to realize their functions, and for example, exclusive hardware for generating a predetermined function, a computer in which a predetermined function is provided by a program, a predetermined function which is realized inside a computer by means of a program, a combination thereof and so forth are permitted.

Also, the information storage medium in the present invention can be hardware in which a program for making a computer execute various kinds of processing is stored in advance as software, and for example, a ROM (Read Only Memory) and an HDD (Hard Disc Drive) being fixed to an apparatus in which a computer is provided as a part, and a CD (Compact Disc)-ROM and an FD (Floppy Disc) and so forth detachably installed in an apparatus in which a computer is provided as a part are permitted.

Also, the computer in the present invention can be an apparatus capable of reading a program consisting of software to perform a corresponding processing operation, and for example, an apparatus and so forth in which a CPU (Central Processing Unit) is provided as a main part, and a ROM, a RAM (Random Access Memory), an I/F (Interface) and so forth are connected thereto if necessary are permitted.

In addition, to make the computer execute the various kinds of operations corresponding to the software in the present invention permits to make the computer control an operation of various kinds of devices, and so forth. For example, to make the computer save various kinds of data permits to store various kinds of data in an information storage medium such as RAM by means of the computer, which is connected thereto in advance, and to store various kinds of data in an internal memory which is provided as a part in the computer, and in case that the information storage medium of the present invention is an FD and so forth, to store various kinds of data therein by the computer, and so forth.

### BRIEF DESCRIPTION OF THE INVENTION

This and other objects, features, and advantages of the present invention will become more apparent upon a reading of the following detailed description and drawings, in which:

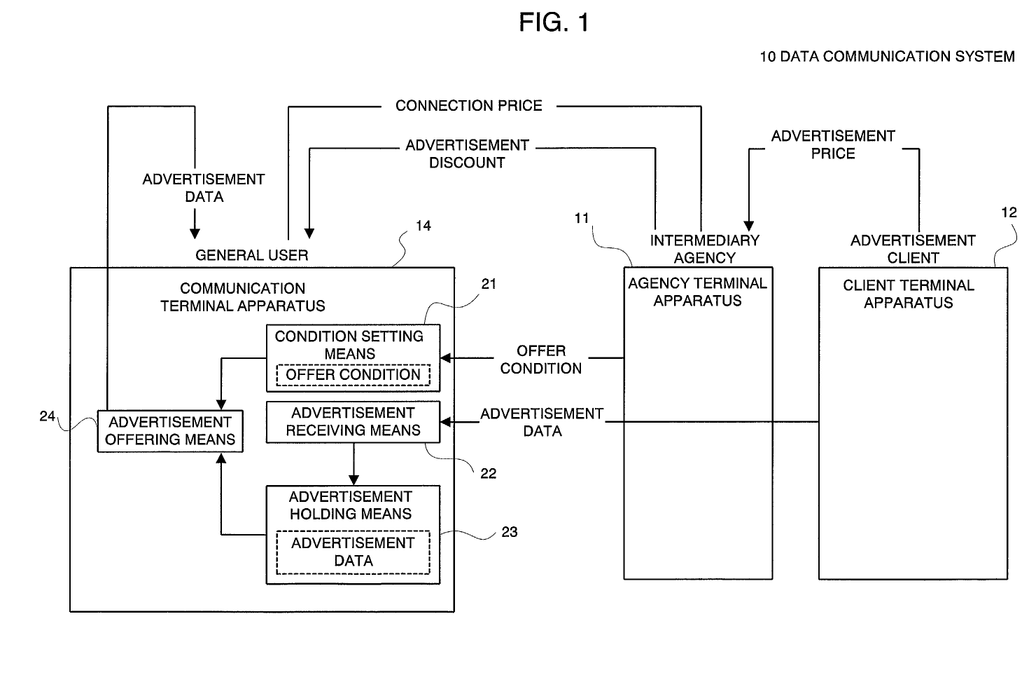

FIG. 1 is a schematic view showing logic structure of a communication terminal apparatus of one embodiment of the present invention;

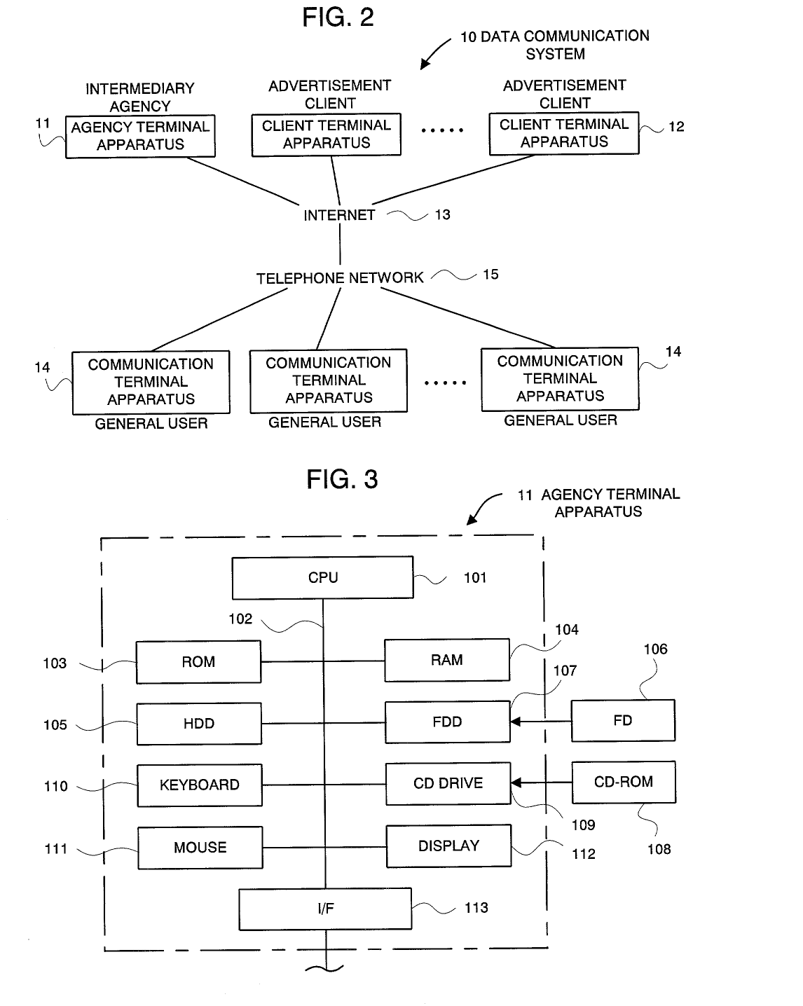

FIG. 2 is a block diagram showing physical structure of a data communication system;

FIG. 3 is a block diagram showing physical structure of an agency terminal apparatus;

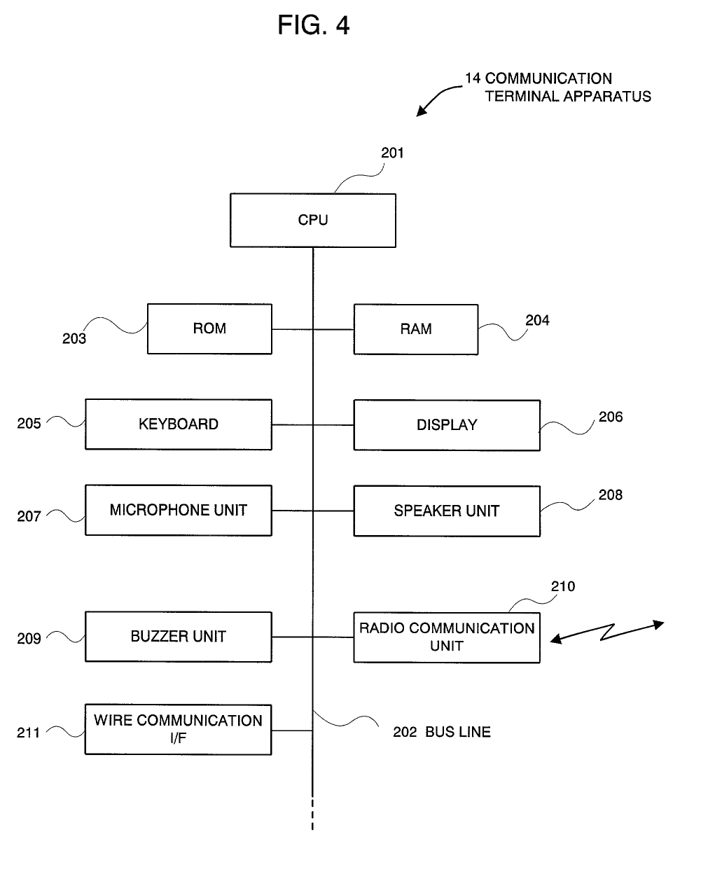

FIG. 4 is a block diagram showing physical structure of the communication terminal apparatus and

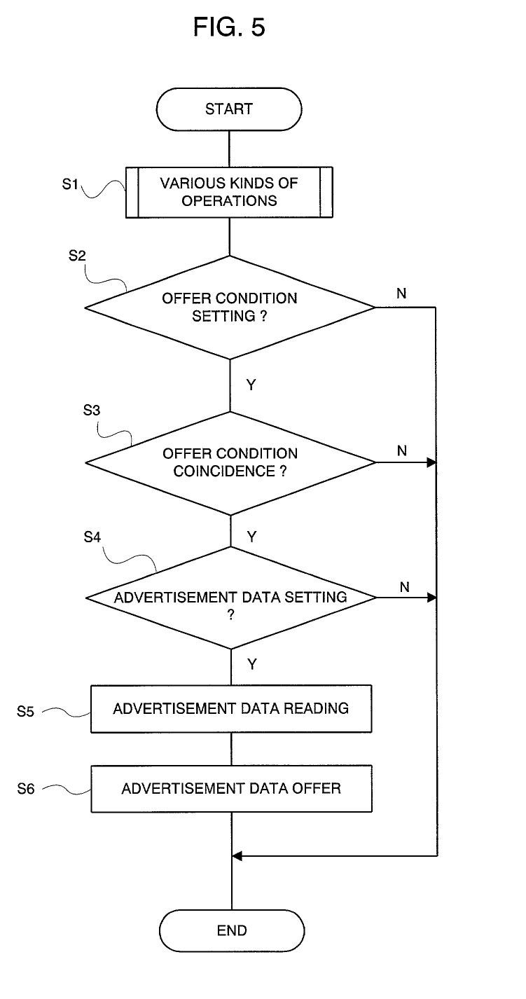

FIG. 5 is a flowchart showing a data processing method by means of the communication terminal apparatus.

### DESCRIPTION OF THE EMBODIMENTS

A first embodiment of the present invention will be explained below referring to FIG. 1 to FIG. 4. As shown in FIG. 2, in a data communication system 10 of this embodiment, one agency terminal apparatus 11 and a plurality of client terminal apparatuses 12 are connected to an internet 13 that is one communication network, and a number of communication terminal apparatuses 14 are connected to a telephone network 15 that is one communication network, and this telephone network 15 and the internet 13 are mutually connected to each other.

The communication terminal apparatuses 14 of this embodiment are consisting of mobile phones, and are owned by general users that are consumers. The client terminal apparatuses 12 are consisting of host computers and so forth owned by advertisement clients, and the business of these advertisement clients is, for example, to sell goods in which communication sales of sales goods are conducted through the internet 13.

The agency terminal apparatus 11 is consisting of a network server and so forth owned by an intermediary agency, and the business of this intermediary agency is to connect the communication terminal apparatuses 14 of the general users to the telephone network 15, and to distribute as data an advertisement of goods of the advertisement clients to the general users.

In addition, actually, the communication terminal apparatuses 14 consisting of the mobile phones are connected to the wire telephone network 15 by radio via a radio base station (not shown), and although this telephone network 15 and the internet 13 are not physically separated from each other completely, assuming the above-mentioned arrangement here, the explanation will be simplified.

The agency terminal apparatus 11 has a CPU 101 as hardware, which is a main part of a computer, and to this CPU 101, hardware such as a ROM 103, a RAM 104, an HDD 105, an FDD (FD Drive) 107 in which an FD 106 is exchangeably installed, a CD drive 109 in which a CD-ROM 108 is exchangeably installed, a keyboard 110, a mouse 111, a display 112 consisting of a CRT (Cathode-Ray Tube), a communication I/F 113 connected to the internet 13 is connected via a bus line 102.

In addition, since the agency terminal apparatus 11 and the client terminal apparatuses 12 have different specifications of each part and performance, but basically, have the same hardware structure, the same names and symbols are used for the agency terminal apparatus 11 and the client terminal apparatuses 12, and the detailed explanation thereof will be omitted.

On the other hand, in the communication terminal apparatuses 14 consisting of the mobile phones, to a CPU 201, a ROM 203, a RAM 204, a keyboard 205, a display 206 consisting of an LCD (Liluid Crystal Display), a microphone unit 207, a speaker unit 208, a buzzer unit 209, a radio communication unit 210, a wire communication I/F 211 and so forth are connected via bus line 202.

The keyboard 205 is utilized for an input operation of telephone numbers, electronic mails and so forth, and the display 206 displays and outputs text data and so forth of the telephone numbers and electronic mails that are operated by an input. The microphone unit 207 is utilized for a voice input of message voice, and the speaker unit 208 outputs the message voice by means of voice.

The buzzer unit 210 outputs termination voice by means of voice in accordance with calls from other communication terminal apparatuses 14, and however, instead of this termination voice, can output sound of variable melody having a plurality of musical scales in accordance with setting data in the RAM 204 and operation control of the CPU 201.

The radio communication unit 210 establishes radio communication with other communication terminal apparatuses 14 by establishing radio connection to the telephone network 15. The wire communication I/F 211 is connected to the agency terminal apparatus 11 and so forth by wire by means of a predetermined connection connector, and establishes wire communication with this wire-connected agency terminal apparatus 11 and so forth.

In the communication terminal apparatuses 14 in this embodiment, the hardware such as the ROM 203 and RAM 204 corresponds to an information storage medium, and in at least one of these, a control program and various kinds of data necessary for various kinds of operations of the CPU 201 are stored as software.

This CPU 201 reads a proper program from the ROM 203 or the RAM 204, and performs various kinds of processing operations, and thereby, as shown in FIG. 1, the communication terminal apparatuses 14 in this embodiment logically has various kinds of means as various kinds of functions, such as condition setting means 21, advertisement receiving means 22, advertisement holding means 23 and advertisement offering means 24.

The condition setting means 21 corresponds to a function and so forth, in which the CPU 201 stores input data from the keyboard 205 in the RAM 204 as data in accordance with a control program stored as data in the ROM 203 and so forth, and offer conditions of an advertisement of goods are set as data by an intermediary agency who is asked by advertisement clients and contracts with the general users.

The advertisement receiving means 22 corresponds to a function and so forth, in which the CPU 201 stores input data from the wire communication I/F 211 in the RAM 204 as data in accordance with the above-mentioned control program, and receives from the agency terminal apparatus 11 advertisement data of the advertisement of the goods, offer conditions of which are set as data in the condition setting means 21.

The advertisement holding means 23 corresponds to a storage area of the RAM 204, where the CPU 201 recognizes data in accordance with the control program, and holds the advertisement data of the advertisement of the goods, which were received as data by the advertisement receiving means 22. These advertisement data are consisting of image data and voice data for propagating sales goods for example, and data compression is applied thereto if necessary.

The advertisement offering means 24 corresponds to a function and so forth, in which the CPU 201 outputs the stored data in the RAM 204 to the display 206 and the speaker unit 208 in accordance with the control program, and offers the advertisement data of the advertisement of the goods, which are held as data in the advertisement holding means 23, to the general users in accordance with the offer conditions that are set as data in the condition setting means 21.

As mentioned above, since the advertisement data are consisting of the image data and the voice data, the offer of the data is performed by a display output by means of the display 206, and by a voice output by means of the speaker unit 208. Accordingly, the offer conditions under which the advertisement data are offered as data in such a manner are set, for example, as the data offer of the advertisement data when the communication terminal apparatuses 14 perform a predetermined operation by means of a manual operation of the general users, and the data offer of the advertisement data when a predetermined operation in association with data communication with other communication terminal apparatuses 14 is performed, and so forth.

The software of such communication terminal apparatuses 14 is stored in the information storage medium such as the RAM 104 as a control program for making the CPU 101 and so forth execute a processing operation such as reception of data settings of offer conditions of an advertisement of goods, reception of advertisement data of the advertisement of the goods, these offer conditions of which are set as data, storage of these advertisement data of the advertisement of the goods, which were received as data, and an offer of these advertisement data of the advertisement of the goods, which were stored as data, to the general users as data in accordance with the offer conditions that were set as data.

In the above-mentioned arrangement, an advertisement distribution method by means of the data communication system 10 of this embodiment will explained below. First, the business of the intermediary agency is to connect the communication terminal apparatuses 14 of the general users to the telephone network 15, and to distribute as data an advertisement of goods of the advertisement clients to the general users.

Accordingly, for example, the intermediary agency establishes a homepage in the internet 13 by means of the agency terminal apparatus 11, and collects general users who purchase the communication terminal apparatuses 14 at the homepage and connect them to the telephone network 15, and collects advertisement clients who want to distribute an advertisement of goods to the general users as data.

And, in case that the advertisement clients who inspects this homepage by means of the client terminal apparatuses 12 desire an offer of an advertisement to the general user, the advertisement clients transmit a offer request of the advertisement of the goods and advertisement data to the agency terminal apparatus 11 of the intermediary agency by means of the client terminal apparatuses 12 in accordance with guidance of the homepage.

Then, since, in this agency terminal apparatus 11, the advertisement data received by the communication I/F 113 from the internet 13 are held as data in the HDD 105, condition under which the advertisement of the goods can be distributed to the general users is established. Accordingly, in case that the general users desire to purchase the communication terminal apparatuses 14 and connect them to the telephone network 15, the general users purchase the communication terminal apparatuses 14 from the intermediary agency and enter into a contract with respect to the connection to the telephone network 15.

At this time, since the intermediary agency notifies the general users that the connection of the communication terminal apparatuses 14 to the telephone network 15 is a charged service in accordance with time, and proposes that there is a distribution service of the advertisement of the goods, in which an advertisement discount is applied to a connection price, these general users also contract with the intermediary agency with respect to the advertisement distribution if they desire.

In this case, the intermediary agency offers data to the general users by displaying and outputting various kinds of advertisements of goods and a number of offer conditions by means of the display 112 of the agency terminal apparatus 11, and makes the general users select a kind and the number, and offer conditions of the advertisements of the goods, which should be distributed as data to the communication terminal apparatuses 14.

Then, when the general users select the advertisements of the goods and the offer conditions at their requests, in accordance with this selection, the intermediary agency sets the offer conditions in the RAM 204 as data by means of a manual operation via the keyboard 205 of each communication terminal apparatus 14, and connects the agency terminal apparatus 11 to the communication terminal apparatuses 14 by wire by means of a connection connector, and inputs the advertisement data.

As shown in FIG. 5, the communication terminal apparatuses 14 in which the offer conditions are set as data in such a manner and the advertisement data are input as data offer the advertisement data by means of a manual operation of the general users or when a predetermined operation in association with data communication with other communication terminal apparatuses 14 is performed.

In this case, every time various kinds of operations are executed (STEP S1), the communication terminal apparatuses 14 confirm whether the offer conditions are set as data (STEP S2), and if this is confirmed, data coincidence between an execution operation and the offer conditions is confirmed (STEP S3). If this is also confirmed, whether advertisement data corresponding to the offer conditions are set as data is confirmed (STEP S4), and if this is confirmed, the advertisement data corresponding to the offer conditions are read and offered as data (STEPS S5, S6)

Here, as mentioned above, various kinds of examples in which the communication terminal apparatuses 14 offer the advertisement data in accordance with the offer conditions will be particularly shown below. First, when the general users performs an input operation of telephone numbers and electronic mails by means of the keyboard 205 of their own communication terminal apparatuses 14, in accordance with this, the telephone numbers and so forth are displayed and output on the display 206, and however, it is possible to display and output image data of an advertisement of goods on the display 206 as far as these display and output are not hindered.

As a method of displaying and outputting the advertisement data as far as the original display and output are not hindered in such a manner, it is possible to perform the original display and output in a part of the display 206 and concurrently display and output the advertisement data in other part, to display and output the advertisement data on the display 206 when the input operation by means of the keyboard 205 is started or finished, or to perform the original display and output on the display 206 when the input operation by means of the keyboard 205 continues and display and output the advertisement data when the input operation is interrupted.

Further, the general users can perform a manual operation of the keyboard 205 of the communication terminal apparatuses 14 to display and output information contents and electronic mails that are received as data on the display 206, and various kinds of operation screens are also displayed and output in accordance with the manual operation of the keyboard 205, and however, as far as these display and output are not hindered, it is possible to display and output image data of an advertisement of goods on the display 206.

Also, the communication terminal apparatuses 14 of this embodiment display and output a start-up screen on the display 206 when a main power is turned on by means of a manual operation of the keyboard 205, and in queued condition where the keyboard 205 is not manually operated, a queued screen is displayed and output on the display 206, and however, it is possible to display and output image data of an advertisement of goods on the display 206 for these start-up screen and queued screen.

Also, the communication terminal apparatuses 14 of this embodiment output termination voice by voice by means of the buzzer unit 209 when they are called by other communication terminal apparatuses 14, and however, for this termination voice, it is possible to output voice data of an advertisement of goods by voice. Similarly, the communication terminal apparatuses display and output a termination screen on the display 206 when they are called by other communication terminal apparatuses 14, and however, for this termination screen, it is possible to output image data of an advertisement of goods by voice.

Also, when the communication terminal apparatuses 14 of this embodiment perform data communication of a voice message with other communication terminal apparatuses 14 by means of a voice input via the microphone unit 207 and a voice output via the speaker unit 208, as far as the voice output is not hindered, it is possible to output the advertisement data by voice.

As a method of outputting the advertisement data by voice as far as the original voice output is not hindered in such a manner, it is possible to output the advertisement data by voice when the voice message is started or finished, to output the advertisement data by voice when the voice message is interrupted, or to output the advertisement data as BGM (Back Ground Music) of small sound volume in the midst of the voice message.

Also, as mentioned above, when the communication terminal apparatuses 14 of this embodiment perform data communication of a voice message with other communication terminal apparatuses 14, it is also possible to transmit voice data of an advertisement of goods to other communication terminal apparatuses 14 with which the communication terminal apparatuses 14 of this embodiment perform voice communication. Similarly, when the communication terminal apparatuses 14 of this embodiment transmit electronic mails to other communication terminal apparatuses 14, it is also possible to add text data or image data of an advertisement of goods to the electronic mails.

Further, the general user can manually operate the keyboard 205 of the communication terminal apparatuses 14 at their requests to read the advertisement data, and it is also possible to display and output these advertisement data on the display 206 and to output them by voice to the speaker unit 208 or the buzzer unit 209.

In addition, since generally an available period of an advertisement of goods is limited, for example, the intermediary agency collects the communication terminal apparatuses 14 from the general users periodically, once per month, and updates the advertisement data. At this time, since the intermediary agency can examine the collected communication terminal apparatuses 14 and confirm the existence of falsification and elimination of the advertisement data and the offer conditions, in case that the falsification or elimination is found for example, the intermediary agency demands forfeit in accordance with a contract clause without performing the advertisement discount. Also, since the intermediary agency can examine the collected communication terminal apparatuses 14 and confirm the number and a time period of the offers of the advertisement data, in accordance with these, it is also possible to determine an amount of the advertisement discount.

In the advertisement distribution method of this embodiment, as mentioned above, since the intermediary agency inputs the advertisement data of an advertisement of goods, which was asked by the advertisement clients, to the communication terminal apparatuses 14 of the general users at their requests, and the communication terminal apparatuses 14 that are always carried and used at each place by these general users offer the advertisement data in accordance with a predetermined operation, it is possible to provide the general users with the advertisement of the goods with good efficiency.

Since, by specifically setting data when the communication terminal apparatuses 14 are manually operated or when data communication is being performed, as the offer conditions of the advertisement of the goods, the advertisement of the goods can be offered to the general users who positively use the communication terminal apparatuses 14, it is possible to improve an advertisement effect.

Further, since the advertisement of the goods, which is input to the communication terminal apparatuses 14 as data, and the offer conditions that are set as data selected by the general users as their requests, the data offer of the advertisement of the goods does not provide unpleasant feeling to the general users. In addition, since the data offer of the advertisement of the goods is performed as far as the original function of the communication terminal apparatuses 14 is not hindered and in a form appropriate for the original function, it is possible to fully utilize various kinds of functions of the communication terminal apparatuses 14 and perform a good data offer of the advertisement of the goods.

Also, since the communication terminal apparatuses 14 of this embodiment can also transmit the advertisement data to other communication terminal apparatuses 14 with which data communication is conducted, it is possible to conduct data distribution with good efficiency to not only the general users who entered into a contract with respect to the advertisement of the goods, but also a number of general users.

Furthermore, since the advertisement discount is subtracted from a connection price for using the communication terminal apparatuses 14 by the general users, it is possible to make the general users positively participate in the data distribution of the advertisement of the goods by the communication terminal apparatuses 14, and it is possible to provide the advertisement of the goods to a number of general users with good efficiency. Even though, in such a manner, the advertisement discount is subtracted from the connection price of the communication terminal apparatuses 14, which is collected by the intermediary agency from the general users, since the intermediary agency collects an advertisement price of the advertisement of the goods from the advertisement clients, a profit is not be decreased.

Also, if the advertisement clients transmit the advertisement data to the intermediary agency only one time, since the intermediary agency inputs the advertisement data to the communication terminal apparatuses 14 of a number of general users, and these input advertisement data are repeatedly offered to the general users from the communication terminal apparatuses 14, it is possible to reduce a work load of the advertisement clients and the intermediary agency while the advertisement of the goods is distributed as data to a number of general users.

Specifically, since the advertisement clients transmit the advertisement of the goods as advertisement data to the agency terminal apparatus 11 of the intermediary agency from the client terminal apparatuses 12, in the agency terminal apparatus 11, it is possible to manage the advertisement data by means of almost automatic mechanical work, and it is also possible to promptly input the received advertisement data to the communication terminal apparatuses 14 of the general users.

In addition, the present invention is not limited to the above-described embodiments, and various kinds of modifications are permitted without deviating from its scope. For example, although in the above-described embodiments it is exemplified that the intermediary agency manually operates the communication terminal apparatuses 14 of the general users to set the offer conditions of the advertisement of the goods as data, it is possible to perform the data setting of the offer conditions in these communication terminal apparatuses 14 from the agency terminal apparatus 11 that is connected by wire, and it is also possible to perform it by utilizing radio communication with the communication terminal apparatuses 14.

Similarly, although in the above-described embodiments it is exemplified that the intermediary agency inputs the advertisement data from the agency terminal apparatus 11 that is connected by wire to the communication terminal apparatuses 14 of the general users, it is possible to perform the data input of these advertisement data by means of radio communication with the communication terminal apparatuses 14. Specifically, as mentioned above, since generally it is preferable to suitably update the advertisement data, for reducing work load of the intermediary agency and the general users, it is also preferable to transmit the updated advertisement data by radio to the communication terminal apparatuses 14.

However, if the advertisement data and the offer conditions are transmitted to the communication terminal apparatuses 14 by radio in such a manner, it becomes difficult for the intermediary agency to examine the falsification and elimination of the advertisement data and the offer conditions as mentioned above. In other words, since whether the advertisement data and the offer conditions are remotely transmitted or directly input has mutually merit and demerit, it is preferable to select the most suitable one by taking various kinds of conditions into account.

Further, although in the above-described embodiments it is exemplified that the intermediary agency subtracts the advertisement discount from the connection price for the communication terminal apparatuses 14, for example, it is also possible to make the connection price completely free, and it is not impossible that the intermediary agency or the advertisement clients pay the general users the advertisement price.

Also, although in the above-described embodiments the mobile phones are assumed as the communication terminal apparatuses 14 of the general users, for example, for the communication terminal apparatuses of the general users, a personal computer and so forth fixedly installed at home are also available. In this case, it is possible to logically establish various kinds of means 21 - 24 as predetermined functions in the personal computer by means of predetermined application programs, and it is possible to install the application programs in the personal computer from an information storage medium such as a CD-ROM and an FD.

In the advertisement distribution method of the present invention, when the intermediary agency is asked by the advertisement clients to offer an advertisement of goods to the general users, this intermediary agency enters into a contract with the general users with respect to data distribution of the advertisement of the goods, and sets offer conditions thereof as data in the communication terminal apparatuses, and when the intermediary agency distributes advertisement data of the advertisement of the goods as data from the agency terminal apparatus to the communication terminal apparatuses in which these offer conditions are set as data, these distributed advertisement data of the advertisement of the goods are held in the communication terminal apparatuses as data, and these communication terminal apparatuses offer these held advertisement data of the advertisement of the goods to the general users as data in accordance with the offer conditions that were set as data, and thereby,

it is possible to offer the advertisement of the goods to a number of general users with good efficiency, and however, since the offer conditions of the advertisement of the goods are corresponding to a desire of the general users, the offer of the advertisement does not provide unpleasant feeling to the general users, and it is possible to improve an advertisement effect.

Also, the communication terminal apparatuses offer the advertisement data as data when performing a predetermined operation by means of a manual operation of the general users, and thereby, since it is possible to offer the advertisement of the goods as data to the general users who positively use the communication terminal apparatuses, it is possible to improve an advertisement effect.

Also, the advertisement data are displayed and output when a predetermined operation is performed in accordance with a manual operation of the communication terminal apparatuses as far as the display and output of various kinds of data are not hindered, and thereby, it is possible to offer the advertisement of the goods as data favorably as far as the original function of the communication terminal apparatuses is not hindered.

Also, the advertisement data are offered as data when a predetermined operation in association with data communication with other communication terminal apparatuses is performed, and thereby,

since it is possible to offer the advertisement of the goods as data to the general users who positively use the communication terminal apparatuses, it is possible to improve an advertisement effect.

Also, when input voice is transmitted as data and received data are output by voice to conduct data communication with other communication terminal apparatuses, the advertisement data are output by voice as far as the voice output is not hindered, and thereby,

it is possible to offer the advertisement of the goods as data favorably as far as the original function of the communication terminal apparatuses is not hindered.

Also, at least one of an offer request of the advertisement of the goods, and the advertisement data is transmitted as data to the agency terminal apparatus of the intermediary agency from the client terminal apparatuses of the advertisement clients via the communication network, and thereby, since, by means of the data transmission from the client terminal apparatuses, the offer request of the advertisement of the goods and the advertisement data can be controlled in real time in the agency terminal apparatus, for example the advertisement data can be promptly distributed as data to the communication terminal apparatuses of the general users.

What is claimed is:

1. An advertisement distribution method in a data communication system in which communication terminal apparatuses of a number of general users conduct data communication at least mutually via a communication network, wherein:
an offer of an advertisement of goods to said general users, which is asked by an advertisement client, is received by an intermediary agency;
this intermediary agency enters into a contract with said general users with respect to data distribution of said advertisement of the goods, and sets offer conditions as data in said communication terminal apparatuses;
advertisement data of said advertisement of the goods are distributed as data to said communication terminal apparatuses in which these offer conditions are set as data, from an agency terminal apparatus of said intermediary agency;
these distributed advertisement data of the advertisement of the goods are held in said communication terminal apparatuses as data; and
these held advertisement data of the advertisement of the goods are offered to said general users as data from said communication terminal apparatuses in accordance with said offer conditions that were set as data.

2. An advertisement distribution method recited in claim 1, wherein said communication terminal apparatuses offer said advertisement data as data when performing a predetermined operation by means of a manual operation of said general users.

3. An advertisement distribution method recited in claim 2, wherein said communication terminal apparatuses display and output various kinds of data when performing the predetermined operation in accordance with the manual operation, and said communication terminal apparatuses display and output said advertisement data as far as the display and output of these various kinds of data are not hindered.

4. An advertisement distribution method recited in claim 1, wherein said advertisement data are offered as data when said communication terminal apparatuses perform the predetermined operation in association with data communication with other of said communication terminal apparatuses.

5. An advertisement distribution method recited in claim 4, wherein said communication terminal apparatuses offer said advertisement data as data in accordance with calls of said other communication terminal apparatuses.

6. An advertisement distribution method recited in claim 1, wherein said communication terminal apparatuses display and output text data to be operated by means of an input and transmitted to said other communication terminal apparatuses, and
said communication terminal apparatuses display and output said advertisement data as far as the display and output of these text data are not hindered.

7. An advertisement distribution method recited in claim 1, wherein said communication terminal apparatuses display and output text data received as data from said other communication terminal apparatuses, and
said communication terminal apparatuses display and output said advertisement data as far as the display and output of these text data are not hindered.

8. An advertisement distribution method recited in claim 1 wherein said communication terminal apparatuses transmit input voice as data and output received data by voice to conduct data communication with said other communication terminal apparatuses, and
said communication terminal apparatuses output said advertisement data by voice as far as the voice output of this data communication is not hindered.

9. An advertisement distribution method recited in claim 1, wherein said communication terminal apparatuses also transmit said advertisement data as data to said other communication terminal apparatuses with which the communication terminal apparatuses conduct data communication.

10. An advertisement distribution method recited in claim 1, wherein said advertisement client comprises a client terminal apparatus for mutually conducting data communication with said agency terminal apparatus via said communication network, and
at least one of an offer request of said advertisement of the goods, and the advertisement data is transmitted as data to said agency terminal apparatus from this client terminal apparatus.

11. A data processing method of communication terminal apparatuses to be utilized for an advertisement distribution method, wherein:
said intermediary agency who is asked by an advertisement client and enters into a contract with said general users receives data settings of offer conditions of said advertisement of the goods;
advertisement data of said advertisement of the goods, these offer conditions of which are set as data, are received as data from an agency terminal apparatus of said intermediary agency;
these advertisement data of said advertisement of the goods, which were received as data, are held as data; and
these advertisement data of said advertisement of the goods, which were held as data, are offered to said general users as data in accordance with said offer conditions that were set as data.

12. A communication terminal apparatus to be utilized for an advertisement distribution method, comprising:
condition setting means in which offer conditions of said advertisement of the goods are set as data by said intermediary agency who is asked by an advertisement client and enters into a contract with said general users;
advertisement receiving means in which advertisement data of said advertisement of the goods, the offer conditions of which are set as data in this condition setting means, are received as data from an agency terminal apparatus of said intermediary agency;
data holding means for holding as data the advertisement data of said advertisement of the goods, which were received as data by this advertisement receiving means; and
advertisement offering means for offering to said general users as data the advertisement data of said advertisement of the goods, which were held as data in this advertisement holding means, in accordance with said offer conditions that were set as data in said condition setting means.

13. A data communication system comprising:
an agency terminal apparatus of an intermediary agency;
communication terminal apparatuses for a number of general users, each of said communication terminal apparatuses having; condition setting means in which offer conditions of said advertisement of the goods are set as data by said intermediary agency who is asked by an advertisement client and enters into a contract with said general users;
advertisement receiving means in which advertisement data of said advertisement of the goods, the offer conditions of which are set as data in this condition setting means, are received as data from an agency terminal apparatus of said intermediary agency;
data holding means for holding as data the advertisement data of said advertisement of the goods, which were received as data by this advertisement receiving means; and
advertisement offering means for offering to said general users as data the advertisement data of said advertisement of the goods, which were held as data in this advertisement holding means, in accordance with said offer conditions that were set as data in said condition setting means,
a communication network for connecting a number of these communication terminal apparatuses, said agency terminal apparatus and said client terminal apparatus to each other.

14. An information storage medium in which software is stored, which is readable by computers of communication terminal apparatuses to be utilized for an advertisement distribution method, the information storage medium storing a program for making said computers execute:
receiving data settings of offer conditions of said advertisement of the goods by said intermediary agency that is asked by an advertisement client and enters into a contract with said general users;
receiving as data advertisement data of said advertisement of the goods, these offer conditions of which are set as data, from an agency terminal apparatus of said intermediary agency;
holding as data these advertisement data of the advertisement of the goods, which were received as data; and
offering these advertisement data of the advertisement of the goods, which were held as data, to said general users as data in accordance with said offer conditions that were set as data.
